(19) United States
(12) Patent Application Publication
(10) Pub. No.: US 2026/0127230 A1
(43) Pub. Date: May 7, 2026

(54) MULTI-STAGE DOCUMENT STORAGE FOR FACILITATING CODE-BASED RETRIEVAL

(71) Applicant: Optum, Inc., Minnetonka, MN (US)

(72) Inventors: Zahra Mahmoodzadeh POORNAKI, Laguna Niguel, CA (US); Fazlolah MOHAGHEGH, Frisco, TX (US); Jagadish VENKATARAMAN, Menlo Park, CA (US); Hamid Reza HASSANZADEH, Suwanee, GA (US)

(21) Appl. No.: 18/936,574

(22) Filed: Nov. 4, 2024

(51) Int. Cl. G06F 16/93; G06F 16/2457; G06F 16/9538

(52) U.S. Cl. CPC G06F 16/93; G06F 16/24578; G06F 16/9538

(57) ABSTRACT

Various embodiments of the present disclosure provide automated data storage and code-based retrieval techniques for improving search engine performance. The techniques apply a multi-stage machine learned autonomous coding pipeline to generate a search template for an input document by extracting a text segment from the input document, executing a coding query to receive a query response, determining that the query response is a null query response, and responsive to the null query response, generating a segment embedding based on the text segment, generating a text-code pair for the text segment based on an embedding similarity score between the segment embedding and a code embedding, storing the text-code pair within the text-code datastore, and modifying the search template by storing a code of the text-code pair in association with the text segment.

### BACKGROUND

Traditional search engines may process queries by identifying textual matches between the query and candidate search results. While this allows for searching within natural language documents, the search results are inconsistent and lead to inefficiencies and potential errors in downstream decision-making processes. This prevents the use of existing search engines for the identification and application of complex authorization criteria defined by natural language documents, which prevents the automation of the interpretation of the natural language documents and the application of the authorization criteria defined therein to user queries. Due to these challenges, human expertise is traditionally leveraged to extract relevant information from natural language documents and apply the extracted information to specific use cases, which is time-consuming, prone to subjective interpretation leading to inconsistent outcomes, and impractical at scale.

These technical challenges are compounded when queries are related to standardized coding systems that require consistent resolutions for different textual expressions of the same code. Traditional automated search engines have attempted to address these challenges through basic keyword matching or rule-based approaches. However, these techniques fail to comprehensively address the nuances of natural language, variations in code terminology, and the evolving nature of coding systems.

### BRIEF DESCRIPTION OF THE DRAWINGS

FIG. 1 depicts a block diagram of an example architecture in accordance with some embodiments of the present disclosure.

FIG. 2 depicts a block diagram of an example predictive data analysis computing entity in accordance with some embodiments of the present disclosure.

FIG. 3 depicts a block diagram of an example client computing entity in accordance with some embodiments of the present disclosure.

FIG. 4 depicts a dataflow diagram of an example multi-stage autonomous coding pipeline and compatible code-based retrieval techniques in accordance with some embodiments of the present disclosure.

FIG. 5 depicts a flowchart diagram of an example process for implementing a first, storage, stage of the multi-stage autonomous coding pipeline in accordance with some embodiments of the present disclosure.

FIG. 6 depicts a flowchart diagram of an example process for implementing a code-based retrieval technique in accordance with some embodiments of the present disclosure.

FIG. 7 depicts a flowchart diagram of an example process for implementing a second, modification, stage of the multi-stage autonomous coding pipeline in accordance with some embodiments of the present disclosure.

### DETAILED DESCRIPTION

Various embodiments of the present disclosure solve technical challenges with traditional query systems by leveraging a multi-stage autonomous coding pipeline to enable improved code-based retrieval systems. The multi-stage autonomous coding pipeline comprises an storage stage, a maintenance stage, and/or a query resolution stage that collectively enable reliable code-based retrieval systems through a series of data transformation, storage, and/or monitoring operations. By doing so, the techniques of the present disclosure enable code-based retrieval systems capable of improved responses at the cost of less computing resources and/or time. To overcome performance deficiencies with traditional search engines, the multi-stage autonomous coding pipeline augments adaptive datastores (e.g., lookup tables for dynamically changing and increasing data) with embedding techniques to efficiently transform text to a searchable code template that is tailored to code-based retrieval. By doing so, the techniques of the present disclosure provide a search repository that may be autonomously augmented as new text-based documents are created and/or as code(s) and/or their definitions change over time. This allows for code-based retrieval techniques that may improve response and/or prediction consistency, while addressing the nuances of and/or diversity in natural language, variations in code terminology, and/or the evolving nature of coding systems. This, in turn, enables code-based retrieval with improved accuracy, precision, false negative rate, recall, and/or F1 score and/or reduced processing times and/or resource expenditures and/or consumption compared to traditional search engines.

In a first stage, a storage stage, the multi-stage autonomous coding pipeline implements a series of operations to efficiently transform a text-based document into a search template designed for code-based retrieval systems. To do so, some embodiments of the present disclosure provide a branched processing technique that leverages a unique combination of natural language processing, machine learning, and local retrieval techniques to generate improved search templates and code-based mappings with enhanced efficiency and accuracy. The branched processing technique selectively applies (e.g., via a first branch) machine learned embedding models to generate text-code pairs that semantically map text segments across a set of input documents to codes defined within a coding domain. To reduce the use of processing resources, historical text-code pairs may be stored and reused (e.g., via a second branch) to process a new input document. By doing so, the branched processing technique may learn new text-code pairs (e.g., by storing one or more multiple historical text segments in associated with a code) as new input documents are pre-processed and stored within a search repository. This, in turn, incrementally improves the storage speed and efficiency over time, while maintaining a consistent interpretation of codes within a coding domain despite different use cases reflected by a set of different input documents that may be input from a set of different sources. These performance increases enable the branched processing technique to automate the interpretation and digitization of text-based documents to bridge the gap between human-readable text and machine-processable codes, enabling more efficient, consistent, and accurate document processing, downstream predictions, and/or decision-making.

In a second stage, a maintenance stage, the multi-stage autonomous coding pipeline implements a series of operations to continuously monitor a state of a coding domain and, responsive to state changes in the coding domain, update a domain-specific search repository. Traditional coding techniques are limited to fixed and pre-populated tables hosted by different parties for their own use. These tables often lack a comprehensive list of codes and are not regularly updated with new versions of the codes, which leads to disconnects in communication between parties interacting within a coding domain. By continuously monitoring the state of the coding domain (e.g., through reception of coding update messages, such as via a pub/sub network, event notification service, etc.), some embodiments of the present disclosure enable the maintenance of an up-to-date, universal translation service between text segments and codes within a coding domain. For example, using the techniques of the present disclosure, code mappings may be automatically updated, following code updates, by simplifying the inputs of a coding process to require only the provision of the code modifications as codes are modified overtime.

In a third stage, a query resolution stage, the multi-stage autonomous coding pipeline implements a series of operations that leverage an input code within a user query to retrieve and/or process the user query. By leveraging codes, rather than text, the code-based retrieval process may enable more precise and automated document searching capabilities. This allows for a transformative shift from language-based to code-based digitization of complex documents, such as healthcare coverage documents, that have traditionally been outside the scope of computer interpretation. This, in turn, enables several post-retrieval processing techniques for user queries. As one example, using the techniques of the present disclosure, authorization decisions may be automatically generated and returned for a user query. The code-based retrieval process, for example, may automatically apply rule sets (e.g., authorization criteria) previously extracted and stored in association with a code to automate a traditionally subjective task of authorizing an activity. Due to the efficiency improvements of the multi-stage autonomous coding pipeline, these decisions may be automatically generated in real time with increased consistency and accuracy across user queries.

Examples of technologically advantageous embodiments of the present disclosure comprise improved: (i) document storage techniques, (ii) autonomous coding techniques, (iii) request handling techniques, and/or (iv) code-based retrieval techniques, among other aspects of the present disclosure. Other technical improvements and advantages may be realized by one of ordinary skill in the art.

### I. OVERVIEW OF EMBODIMENTS

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

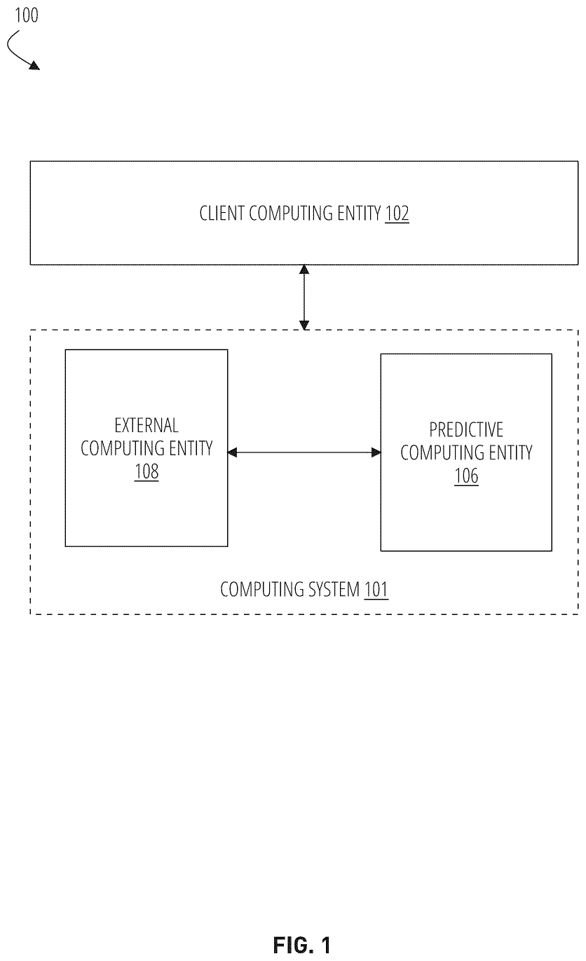

FIG. 1 depicts a block diagram of an example architecture 100 in accordance with some embodiments of the present disclosure. The architecture 100 comprises a computing system 101 configured to receive requests, such as user queries, coding requests, and/or the like, from client computing entities 102, process the requests according to a multi-stage autonomous coding pipeline, and provide response to the client computing entities 102. The example architecture 100 may be used in a plurality of domains and not limited to any specific application as disclosed herewith. The plurality of domains may comprise healthcare, industrial, manufacturing, computer security, to name a few.

In accordance with various embodiments of the present disclosure, one or more machine learned models may be trained to generate embeddings and/or other machine learned outputs. The models may by adapted to an autonomous coding pipeline that may be configured to autonomously code a text segment with respect to a coding domain. Some techniques of the present disclosure may adapt traditional models to a cohesive framework for more efficiently handling autonomous coding processes.

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate a code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., storage techniques, code-based retrieval techniques) described herein. The external computing entities 108, for example, may comprise and/or be associated with one or more entities that may be configured to receive, transmit, store, manage, and/or facilitate datasets, such as text-code datastores, vector datastores, search repositories, and/or the like. The external computing entities 108, for example, may comprise data sources that may provide such datasets, and/or the like to the predictive computing entity 106 which may leverage the datasets to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for a target coding domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

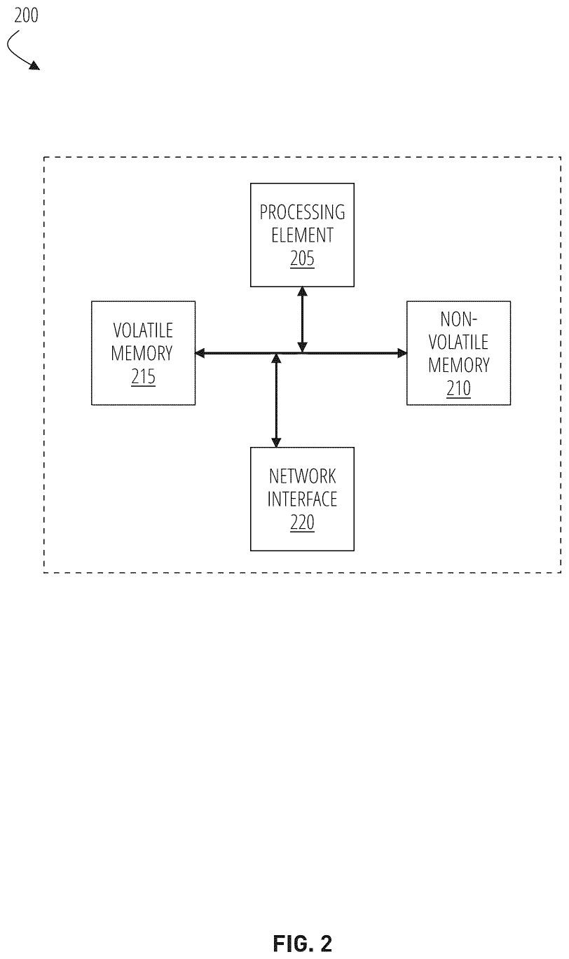

FIG. 2 depicts a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably) and/or volatile memory 215 (also referred to as volatile media, storage, memory storage, memory circuitry, and/or similar terms used herein interchangeably), as discussed above.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium including random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As will be recognized, the non-volatile memory 210 and/or the volatile memory 215 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, including as computer program products that comprise articles of manufacture. Such computer program products may comprise one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (including volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

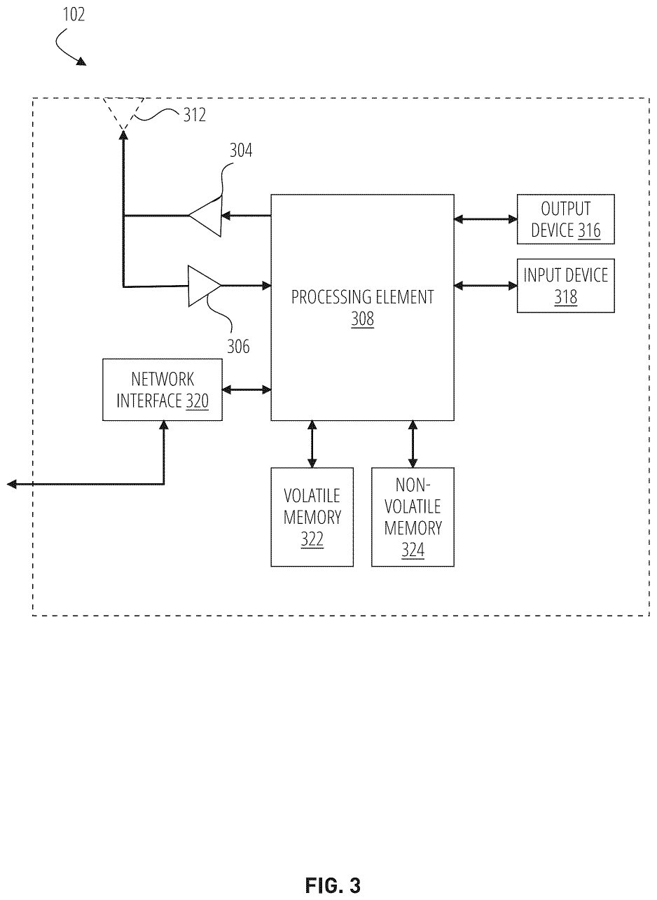

FIG. 3 depicts a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., including executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. EXAMPLE SYSTEM OPERATIONS

As indicated, various embodiments of the present disclosure make important technical contributions to computer functionality. In particular, systems and methods are disclosed herein that implement machine learned techniques to improve machine learned model performance with respect to various tasks, including autonomous document storage and query resolution. By doing so, the machine learned techniques of the present disclosure enables improved machine learned models that, when executed on a computer, reduce the processing, memory, and temporal requirements for various computing tasks. This, in turn, may improve the functionality of a computer with respect to various computing tasks, including computer security, classification, prediction, and the like.

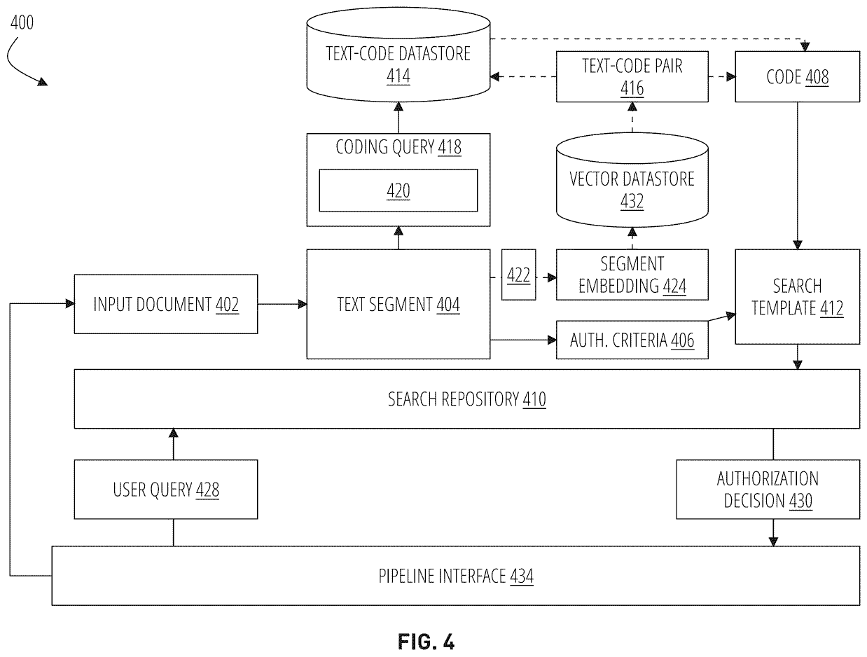

FIG. 4 depicts a dataflow diagram of an example multi-stage autonomous coding pipeline and compatible code-based retrieval techniques in accordance with some embodiments of the present disclosure. The multi-stage autonomous coding pipeline comprises a storage stage, a maintenance stage, and query resolution stage that collectively enable an accurate code-based retrieval system that solves technical challenges encountered by traditional search engines. Specifically, during a storage stage, the multi-stage autonomous coding pipeline may be configured to store an input document 402 by transforming the input document 402 to a search template 412 that is designed for code-based retrieval. In addition, or alternatively, during the maintenance stage, the multi-stage autonomous coding pipeline may be configured to continuously, periodically, and/or discretely receive a code update message indicating a modification to a set of codes associated with a code domain. For example, the modification may comprise adding, altering, or deleting one or more codes defined within a coding domain. In some examples, the techniques may comprise dynamically modifying previously generated search template(s) and/or dynamically modifying the search template generation process and/or component(s) based at least in part on one or more code update messages to compensate for code modifications identified by the code update messages. Finally, during the query resolution stage, the multi-stage autonomous coding pipeline may process a query by retrieving text segments from a search repository 410 of search templates using only an input code and/or a document identifier. By doing so, the techniques of the present disclosure may quickly, efficiently, and accurately respond to queries which, may in turn, enable automated query processing operations traditionally outside the scope of computer capabilities. By way of example, using the techniques of the present disclosure, the multi-stage autonomous coding pipeline may enable automated authorization decisions and other post processing tasks that rely on query retrieval speed, accuracy, and efficiency.

In some embodiments, an input document 402 is received for a search repository 410. The input document 402, for example, may be received through a storage request provided by a party associated with a coding domain. In some examples, the storage request that may comprise an API call, via a pipeline interface 434, to a computing system, program, service, and/or the like, that is configured to implement the multi-stage autonomous coding pipeline and/or one or more code-based retrieval techniques thereof.

The input document 402 may comprise a text-based document associated with a coding domain. An input document 402, for example, may comprise a set of text segments that relate to one or more codes defined within a coding domain. As described herein, when ingested, the input document 402 may be codified by mapping the set of text segments to the one or more codes to generate a search template 412 for the input document 402. For example, an input document 402 may be provided in various text-based formats, such as a plain text file, a portable document format (PDF), and/or the like and comprise complex language and terminology specific to a particular coding domain. In some examples, the multi-stage automated coding pipeline may be applied to the input document 402 to extract text segments from the text-based format and transform the text segments to one or more defined codes to generate a searchable, code-based representation of the input document 402.

The input document 402 may be domain specific and may be based on a coding domain. In some embodiments, the coding domain is a prediction space in which a set of codes is defined. A coding domain may comprise any domain in which codes are used to capture an actionable insight. For example, a coding domain may be a computer performance monitoring domain that leverages a set of codes to identify defined computing activities, defects, and other features predictive of a computer's performance. Other examples of coding domains may comprise healthcare domains, cybersecurity domains, and/or the like. As an example, a healthcare domain may leverage a systematic coding of medical procedures and diagnoses for managing the health of participants within a healthcare system. These, medical codes, may comprise CPT codes, Clinical Modification (CM), Healthcare Common Procedure Coding System (HCPCS) codes, and/or the like that may be assigned to a participant based on the participant's activity within the healthcare domain (e.g., as reflected by a medical chart, etc.). CM codes, for example, may comprise a set of codes developed and maintained by the World Health Organization (WHO) that offers a system for classifying diseases, with detailed categorization of various signs, symptoms, abnormal findings, complaints, social circumstances, and external causes of injury or disease. CPT codes may comprise another set of codes developed by another agency (e.g., the American Medical Association (AMA)) that comprise alphanumeric characters utilized by healthcare providers to document procedures and services performed during a healthcare visit. HCPCS codes may comprise yet another set of codes developed and maintained by yet another agency for classifying medical procedures and diagnoses.

In some embodiments, a code 408 is one or a sequence of characters and/or numerals that describe an actionable insight. A code 408, for example, may comprise a representation for an actionable insight (e.g., a medical procedure, a computer defect, a computer state, a biochemical state, etc.) within a coding domain. A code 408 may be one of a set of codes defined within the coding domain to identify one or more actionable insights. By way of example, in a healthcare domain, a code 408 may comprise a current procedural terminology (CPT) code including either 5-digit numeric or alphanumeric characters, a list of healthcare common procedure coding system (HCPCS) codes including a single letter followed by four numeric digits, and/or the like.

In some examples, a code 408 may comprise a codified representation for a textual description that describes an actionable insight of the code 408. The textual description, for example, may comprise a term, a phrase, one or more phrases, sentences, and/or the like. By way of example, in a healthcare domain, a CPT code may comprise a 5-digit numeric that corresponds to a textual description of a medical procedure.

Coding domains with disparate sets of codes managed by third parties, such as the healthcare example above, present several technical challenges to autonomous coding systems due to the intricate and variable nature of coding languages that may differ across agencies and coding systems. These challenges are exacerbated by participants within coding domains that use their own, individualized language to describe the actionable insights corresponding to the codes. Some embodiments of the present disclosure solve these technical challenges using a multi-stage automated coding pipeline that effectively matches individual codes (e.g., codes defined across different agencies and/or coding systems, etc.) to segments of text (e.g., natural language text defined across different participants, etc.) used across a coding domain to create universal code to text mappings for downstream processes. By doing so, some embodiments of the present disclosure may provide, maintain, and continuously augment a codified search repository 410 that may form the foundation of an improved, code-based query system with increased retrieval speeds and capable of more comprehensive and anticipatory results compared with traditional techniques that are constrained by natural language inconsistencies.

In some examples, the information, form, and content of an input document 402 may be based on the coding domain. In a computer security domain, for example, an input document 402 may describe one or more network protocols, technical specifications, error codes, and/or any other text segments related to a code 408 defined within the computer security domain. As another example, in a health care domain, an input document 402 may describe one or more policies, benefits, exclusions, or other relevant information for a healthcare coverage agreement. In some examples, input documents may be stored in a search repository 410 for domain-specific information retrieval.

In some embodiments, the search repository 410 is one or a set of memory locations accessible to a retrieval system. A search repository 410, for example, may comprise a domain-specific search repository 410 that comprises a set of domain-specific search templates and/or data associated therewith. The data within the search repository 410 may be stored in one or more different data structures, including a graph-based data structure, linked list, relational database, and/or the like. In some examples, the search repository 410 may be updated with additional domain-specific search templates through a storage process that leverages a multi-stage automated coding pipeline to transform an input document 402 into a search template 412. In this way, a search repository 410 may comprise a collection of search templates that correspond to text-based input documents associated with a particular coding domain.

In some embodiments, a search template 412 for the input document 402 is generated by extracting (e.g., using one or more natural language processing (NLP) techniques) a text segment 404 from the input document 402. In some embodiments, a text segment 404 is a portion of text extracted from the input document 402 that represents a distinct piece of information. A text segment 404 may vary in length, from a single phrase to multiple sentences, depending on the complexity and coherence of the information it contains.

A text segment 404 may depend on a coding domain. For instance, in a computer performance monitoring domain, a text segment 404 may comprise one or more terms and/or phrases that describe a computer's performance, a condition, and/or the like, using the words of a particular program, operating system, and/or the like. As another example, in a healthcare domain, a text segment 404 may describe a medical term, process, concept, and/or the like, using the words of a healthcare provider. By way of example, a text segment 404 in a healthcare domain may comprise “non-surgical treatment of obesity,” which may relate to a medical code without matching the medical code's textual description.

A text segment 404 may comprise one or more terms and/or phrases that correspond to a defined code 408 within a coding domain or one or more modifiers for the defined code 408. For example, a text segment 404 may be extracted from an input document 402 using one or more natural language processing techniques, such as named entity recognition (e.g., Clinical NER), and/or the like. A text segment 404 may be a semantic neighbor (e.g., semantically related as determined by a distance in embedding space) of a code 408, a modifier for a code 408 (e.g., authorization criteria 406), or unrelated to a code 408. By way of example, a text segment 404 may comprise natural language text that describes the semantic equivalent (e.g., a synonym) of an actionable insight that corresponds to a code 408. As another example, a text segment 404 may comprise natural language text that describes a modifier for an actionable insight. The modifier, for example, may comprise authorization criteria 406 that defines one or more instructions for handling a particular actionable insight.

In some embodiments, the authorization criteria 406 is a text segment 404 that describes one or more conditions for a code 408 within an input document 402. The authorization criteria 406, for example, may be based on a coding domain and/or an input document 402. For example, in a healthcare domain, the authorization criteria 406 may comprise exclusion criteria defined by a healthcare coverage document for a particular healthcare code. As other examples, the authorization criteria 406 may comprise access criteria defined by a security profile for a particular access code, and/or the like.

In some example, a search template 412 is generated by extracting (e.g., using the NLP techniques) a set of authorization criteria 406 for a text segment of a set of text segments that relate to a code 408 defined within a coding domain. The search template 412 may be prepopulated with the set of text segments and mapped to the authorization criteria 406.

In some embodiments, a search template 412 is a structured representation of an input document 402. A search template 412, for example, may comprise a structured representation of the information extracted from an input document 402. The search template 412 may be designed to facilitate efficient searching and retrieval of specific data points. For example, the search template 412 may serve as an intermediary between an input document 402 and a retrieval system.

In some examples, a search template 412 may comprise a set of structured response entries that respectively correspond to a set of codes defined within a coding domain. For example, a structured response entry of a search template 412 may comprise a code 408 identified from a text segment 404 of the input document 402 and a link (e.g., pointer) to one or more text segments associated with authorization criteria 406 for the code 408. In this manner, a search template 412 may comprise an input document 402 that is transformed into a set of anticipated query responses for a code-based retrieval system. By doing so, a search template 412 for an input document 402 may improve the comprehensiveness, accuracy, and efficiency of a retrieval system, while reducing retrieval speeds. In some examples, a search template 412 may comprise metadata, such as a document identifier corresponding to the input document 402, categorization information associated with the coding domain, and/or the like, to further improve the retrieval speeds of the retrieval system.

One technical challenge of code-based retrieval systems is a reliance on codes that may be (i) dynamically updated by a coding system and/or (ii) indirectly referenced by text segments within an input document 402. These deficiencies prevent the use of code-based retrieval systems within dynamic coding domain. Some techniques of the present disclosure solve these technical challenges using a multi-stage machine learned automated coding pipeline to automatically create a search template 412 from an input document 402 and dynamically update the search template 412 as changes are detected within a coding domain. In some examples, the multi-stage machine learned automated coding pipeline may leverage a text-code datastore 414 to reduce time and processing constraints for the execution of the multi-stage machine learned automated coding pipeline.

In some embodiments, a coding query 418 is executed for the text segment 404 to receive a query response. The coding query 418, for example, may be executed to the text-code datastore 414 of the search repository 410. In some examples, the text-code datastore 414 may comprise a hash table that comprises a set of historical text-code pairs respectively indexed by a set of hashed identifiers. In some examples, a hashed query identifier 420 is generated, using a hashing model, by hashing the text segment 404. The coding query 418 may be executed with the hashed query identifier 420.

In some embodiments, the text-code datastore 414 is one or a set of memory locations accessible to a retrieval system. A text-code datastore 414, for example, may comprise one or more different data structures, including a graph-based data structure, linked list, relational database, and/or the like, that identifies a correspondence between a code 408 and one or more text segments (e.g., from one or more different input documents). A text-code datastore 414, for example, may comprise a set of text-code pairs that serve as a repository of historical mappings between text segments and their corresponding codes.

In some examples, a text-code datastore 414 may comprise a hash table or similar data structure optimized for quick retrieval times. For instance, a text-code datastore 414 may comprise a collection of previously generated text-code pairs indexed, using a hashed identifier, such as a hashed query identifier 420, for quick retrieval. In some examples, a text-code datastore 414 may be locally stored by a storage engine (e.g., a shared copy may be locally stored by a plurality of storage engines with a source copy stored by (i) an external source, (ii) one of the storage engines, or (iii) a set of the storage engines in a distributed ledger) to improve the storage of an input document 402. For instance, during an input document storage stage, the text-code datastore 414 may serve as a local memory source to identify historical text-code pairs that correspond to text segments within an input document 402. By doing so, the text-code datastore 414 may improve storage efficiencies, while ensuring consistency across search templates of a search repository 410 by enabling the reuse of historical mappings between text segments and codes. In some examples, the text-code datastore 414 may be dynamically updated as new text-code pairs are generated or existing ones are modified due to code updates.

In some embodiments, a text-code pair 416 is an association between a specific text segment 404 and a code 408 defined within coding domain. The pairing forms the core of the code-based digitization process, enabling efficient searching and retrieval of information. A text-code pair 416 may comprise a text segment 404 extracted from an input document 402 and a code 408 that best represents the content or meaning of that text segment 404. Text-code pairs are stored in the text-code datastore and incorporated into the search template 412, allowing for rapid, code-based access to relevant information from the original document. In some examples, a text-code pair 416 may be stored with a hashed identifier to improve retrieval times.

In some embodiments, the hashed identifier is an identifier of a text-code pair 416. A hashed identifier, for example, may comprise a hashed portion of a text-code pair 416. By way of example, a hashed identifier may comprise a hash of a text segment 404 of the text-code pair 416. For example, a hashed query identifier 420 may be generated by applying a hashing model (e.g., message digest algorithm (“MD5”), secure hash algorithm (“SHA-3”), cyclic redundancy check (“CRC32”)) to the text segment 404. In addition, or alternatively, another portion (e.g., code, code description, etc.) of a text-code pair 416 may be hashed to generate the hashed identifier.

In some embodiments, a coding query 418 is a request for a code 408 related to an input document 402 and/or a text segment 404 thereof. A coding query 418, for example, may comprise a request for a code 408 mapped to a text segment 404 from the text-code datastore 414. In some examples, the coding query 418 may comprise a hashed query identifier 420. The hashed query identifier 420 may comprise a hash of the text segment 404 extracted from the input document 402. The coding query 418, for example, may comprise an API call to a local and/or remotely located text-code datastore 414 to retrieve a code 408 corresponding to a text segment 404 based on the hashed query identifier 420.

In some embodiments, the query response is a null query. In some embodiments, a null response is a response to the coding query 418. A null response, for example, may comprise an API response from the text-code datastore 414. The null response may indicate that the text-code datastore 414 does not comprise an associated code corresponding to a text segment 404. In some examples, a null response may trigger the performance of an embedding-based matching process. For example, in response to a determination that the query response is a null response, an automated coding process may be performed. Otherwise, the query response may comprise a text-code pair 416 that corresponds to the text segment 404. The search template 412 may be modified by storing the code 408 of the text-code pair 416 within the search template 412 in association with the text segment 404 (and/or authorization criteria 406 associated therewith).

In some embodiments, a segment embedding 424 is generated based on the text segment 404. For example, the segment embedding 424 may be generated using a machine learned encoder model 422. In some embodiments, the machine learned encoder model 422 is a data entity that describes parameters, hyper-parameters, and/or defined operations of a rules-based and/or machine learned model (e.g., model including at least one of one or more rule-based layers, one or more layers that depend on trained parameters, coefficients, and/or the like). A machine learned encoder model 422 may comprise any type of model configured, trained, and/or the like to generate an encoded output, such as an embedding (e.g., code embedding 426, segment embedding 424, etc.), for text. A machine learned encoder model 422 may comprise one or more of any type of machine learned model including one or more supervised, unsupervised, semi-supervised, reinforcement learning models, and/or the like. For instance, a machine learned encoder model 422 may comprise a machine learned language model, such as a bidirectional transformer. By way of example, a machine learned encoder model 422 may comprise a bidirectional encoder-based language model, such as bidirectional encoder representations from transformers (BERT) model, a robustly optimized BERT pretraining approach (RoBERTa) model, and/or the like.

More particularly, the machine learned encoder model 422 may comprise a hardware and/or software architecture having one or more parameters (e.g., coefficient(s), weight(s), biase(s), activation function(s) and/or action function type(s) in examples where the activation function and/or function type is determined as part of training, clustering centroid(s)/medoid(s), partition(s)) determined as a result of training the machine learned encoder model 422 based at least in part on training hyperparameters and/or structural hyperparameters defining the model's architecture. In some examples, structural hyperparameter(s) may define component(s) of the model's architecture and/or their configuration/order, such as, for example, the configuration/order specifying which output(s) of one component are provided as input to other component(s); a number, type, and/or configuration of component(s) per layer, a number of layers of the model, a number of input nodes in an input layer of the model, a number of output nodes of an output layer of the model, component dimension (e.g., input size versus output size), temperature, and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., embedding model(s), generative pre-trained transformer(s) (GPT(s))), neural network(s), multi-layer perceptron(s), Kolmogorov-Arnold network(s), clustering algorithm(s), support vector machine(s), etc.

Additional or alternate hyperparameter(s) (i.e., training hyperparameter(s)) may be used as part of training the machine learned encoder model 422. In some examples, the training hyperparameter(s), in addition to the training data and/or input data, may affect determining the parameter(s) of the machine learned encoder model 422. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like KANs where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate optimization algorithm type (e.g., gradient descent, adaptive, stochastic) used to determine an alteration to one or more parameters of one or more components of the machine-learned model to reduce the loss determined by the loss function, and/or the like. In some examples, the structural hyperparameters and/or the training hyperparameters may be determined by a hyperparameter optimization algorithm or based on user input, such as a software component written by a user or generated by a machine-learned model. The target machine learned model may comprise any type of model configured, trained, and/or the like to generate a prediction output for a model input. The target machine learned model may comprise one or more of any type of machine learning model including one or more supervised, unsupervised, semi-supervised, and/or reinforcement learning models. In some embodiments, the target machine learned model may comprise a single machine-learned model or multiple machine-learned model models configured to perform one or more different stages of a prediction process.

In some embodiments, the segment embedding 424 is a vector representation of a text segment 404. A segment embedding 424, for example, may comprise a dense vector representation of a text segment 404 that is output by the machine learned encoder model 422. A segment embedding 424 may capture a semantic meaning and context of the text in a high-dimensional space, enabling more sophisticated comparison and matching operations. A segment embedding 424 may be created using advanced natural language processing techniques, such as transformer-based models. The segment embedding 424 represents the text segment 404 in a way that preserves its meaning and allows for nuanced comparisons with other embeddings. This is particularly useful when searching for similar concepts or when generating new text-code pairs based on semantic similarity rather than exact text matches.

In some embodiments, a text-code pair 416 is generated for the text segment 404 based on a set of embedding similarity scores respectfully generated between the segment embedding 424 and a set of code embeddings of a vector datastore 432.

In some embodiments, a code embedding 426 is a vectorized representation of a code 408. A code embedding 426, for example, may comprise an embedding that describes a semantic meaning of a code 408. In some examples, a code embedding 426 may be generated by encoding a textual description of a code 408. For instance, a textual description of a code 408 may be input to the machine learning encoder model (e.g., the same model used to generate the segment embedding 424) to receive the code embedding 426. As described herein, embeddings, which involve representing words or sentences as numerical vectors in a high-dimensional space, may be leveraged to capture the semantic meaning and contextual relationships between words within a textual description. By doing so, an embedding, such as the code embedding 426, may enable a machine learning model to effectively match different embeddings according to a semantic similarity expressed by different embeddings.

In some examples, a code embedding 426 may be generated for one or more of a set of codes by encoding a set of textual descriptions respectively corresponding to the set of codes. In some examples, the code embeddings may be stored in a vector datastore 432 for retrieval during one or more stages of a multi-stage automated coding pipeline.

In some examples, a code embedding 426 may capture one or more semantic properties and relationships between different codes defined within a coding domain in a high-dimensional space by taking into account the hierarchical structure, descriptions, and usage patterns of the codes. These embeddings allow for sophisticated comparisons between codes and text segments, enabling the generation of new text-code pairs based on a semantic similarity between a text segment 404 and the code 408 defined within the coding domain. By way of example, a new text-code pair 416 may be generated based on an embedding similarity score between a segment embedding 424 and a code embedding 426.

In some embodiments, the vector datastore 432 is a data structure that describes a set of vectorized representations for a set of codes within a coding domain. A vector datastore 432, for example, may comprise a set of code-vector tuples. A code-vector tuple may comprise a code 408, a code embedding 426, and/or a textual description for the code 408. In some examples, the vector datastore 432 may comprise a code-vector tuple for a code defined within a coding domain (e.g., embeddings for a set of 18,000 procedural codes defined by the AMA). The size of the vector datastore 432 may be based on a total count of codes within a coding domain and/or the dimensions of the set of code embeddings therein.

In some embodiments, an embedding similarity score is a numerical measure of the semantic similarity between two embeddings, such as a segment embedding 424 and a code embedding 426. An embedding similarity score may quantify how closely the meaning of a text segment 404 aligns with the concept represented by a particular code 408. The embedding similarity score may be generated using distance metrics in the high-dimensional embedding space, such as cosine similarity, Euclidean distance, and/or the like. A higher similarity score may indicate a stronger semantic match between a text segment 404 and a code 408. In some examples, an embedding similarity score may be generated between a text segment 404 and a set of codes defined by a coding domain to generate a text-code pair 416 for the text segment 404 by matching the text segment 404 with a code 408 associated with the highest embedding similarity score. In some examples, this embedding-based matching process may be initiated responsive to a null query response that indicates no exact match is found in a text-code datastore. In such a case, the embedding similarity scores may be used to identify the most appropriate code 408 for a given text segment 404, ensuring accurate and contextually relevant code-based digitization.

In some embodiments, the text-code pair 416 is stored within the text-code datastore. In addition, or alternatively, the search template 412 is modified by storing a code 408 of the text-code pair 416 in association with the text segment 404. In some examples, authorization criteria 406 that corresponds to the text segment 404 may be extracted from the input document 402 and stored in association with the text-code pair 416.

In some embodiments, a redundancy check is performed for the search template 412. The redundancy check, for example, may be performed in response to a modification of the search template 412. For instance, the text segment 404 may be one of a set of text segments stored within the search template 412 and a text segment of the set of text segments may be respectively associated with one of a set of previously identified codes. Responsive to the modification of a search template 412, the search template 412 may be searched for a duplicate code assigned to more than one of the set of text segments. A duplicate code, for instance, may be detected based on a comparison between the code 408 and one or more of the set of previously identified codes. Responsive to a match, a data redundancy flag may be generated based on the duplicate code.

In some embodiments, the data redundancy flag is an indicator, marker, and/or the like that identifies a code redundancy within a search template 412. A data redundancy flag, for example, may be generated responsive to a detection of a duplicate or overlapping codes within a search template 412. The data redundancy flag may be triggered responsive to a detection that a newly added code for a text segment 404 matches or conflicts with one or more previously identified codes associated with other text segments in the same search template 412. The data redundancy flag serves to alert users or automated processes of potential inconsistencies or redundancies in the code-based representation of the document, enabling further review or resolution of such overlaps to maintain the integrity and efficiency of the search repository 410.

In some embodiments, the search template 412 is stored within a search repository 410. In some examples, the input document 402 may be associated with a document identifier and the search template 412 may be indexed within the search repository 410 based on the document identifier.

In some embodiments, a user query 428 for the search repository 410 is received that comprises a document identifier and/or an input code. The user query 428, for example, may comprise an API call, via the pipeline interface 434, to a computing system, program, service, and/or the like, that is configured to implement the multi-stage autonomous coding pipeline and/or one or more code-based retrieval techniques thereof.

In some embodiments, the user query 428 is a request for information submitted by a user to the search repository 410. A user query 428 may comprise one or more parameters, such as a document identifier, an input code, and/or the like, that may be used to search the search repository 410 and retrieve relevant information. In some examples, a user query 428 may be processed against one or more search templates of the search repository 410 to efficiently locate and return pertinent text segments, codes, authorization criteria 406, authorization decisions, and/or the like from transformed input documents.

In some examples, a user query 428 may comprise a document identifier, an input code, and/or contextual data (e.g., patient health record, medical claim). The user query 428 may be processed by extracting a search template 412 from the search repository 410 based on the document identifier and searching the search template 412, using the input code, to extract authorization criteria 406 for the input code. In some examples, the input code may be associated with contextual data, such as a medical claim in a healthcare domain. In such a case, the authorization criteria 406 may be compared to the contextual data to automatically determine an authorization decision 430 in response to a user query 428.

In some embodiments, an output text segment is output (e.g., as an API response via the pipeline interface 434) based on the document identifier, the input code, and/or a search template 412 corresponding to the user query 428. In some examples, the output text segment may comprise the authorization criteria 406 associated with the input code. In addition, or alternatively, the output text segment may comprise an authorization decision 430 for the user query 428. The authorization decision 430, for example, may be based on the authorization criteria 406 for an input code. In some embodiments, the authorization decision 430 is one type of user query output. For example, an authorization decision 430 may be generated by applying authorization criteria 406 for an input code to contextual data associated with a user query 428. The contextual data may depend in the coding domain. For instance, in a healthcare domain, the contextual data may comprise a medical claim and the authorization decision 430 may indicate that a particular clinical service, procedure, or item is covered or excluded under a specific insurance plan or policy. An authorization decision 430, for example, may indicate an approval, a denial, or a need for further review of a claim or request for services. In other examples, the contextual data may comprise a debugging report for a computer and the authorization decision 430 may indicate that a particular program is approved, denied, and/or needs further review. In any coding domain, an authorization decision 430 may serve as an automated response to user queries, enabling rapid and consistent interpretation of complex input documents.

In some embodiments, a code restoration process is performed in response to one or more code modifications within a coding domain. For instance, the code 408 may be one of a set of codes defined within a coding domain. A code update message may be received that identifies a code modification to a code definition of the code 408. Responsive to the code update message, one or more text-code pairs associated with the code 408 may be removed from the text-code datastore 414 and one or more of the search templates within the search repository 410 that comprise the code 408.

In some embodiments, the code update message is a data entity that describes a modification to one or more of a set of defined codes within a coding domain. A code update message may comprise a data message from a coding system within the coding domain. The code update message may identify a code modification, a code addition, and/or a code removal. A code modification, for example, may identify a modification to a textual description of a code 408, a code addition may identify a new code, and a code removal may identify a deletion of a code 408. In some examples, the code modification, code addition, and/or the code removal may trigger an action for the text-code datastore 414, the vector datastore 432, and/or the search repository 410. By way of example, in response to a code addition, the textual description of the code 408 may be encoded to generate a code embedding 426 and the code 408, textual description, and the code embedding 426 may be added to the vector datastore 432. In response to a code modification and/or code removal, one or more text-code pairs corresponding to the modified and/or removed code may be deleted from the text-code datastore 414 and/or one or more of the search templates within the search repository 410.

In some embodiment, an automated coding process is re-executed to reassign a code 408 to one or more of the text segments previously mapped to the code. The automated coding process may modify a text-code datastore 414 and/or one or more search templates 412 impacted by the coding update message. For instance, a modified code embedding 426 may be generated for the code 408 based on the code modification. One or more text-code pairs 416 generated for the modified code may be removed from the text-code datastore 414. A new text-code pair 416 may be generated for one or more of the text segments removed from the text-code datastore 414 based on an embedding similarity score between the respective segment embeddings and one or more of the code embeddings of the code vector datastore 432. The text-code pairs may then be restored within the text-code datastore 414 and one or more of the impacted search templates may be restore the code 408 of the text-code pair 416 in association with the text segment 404.

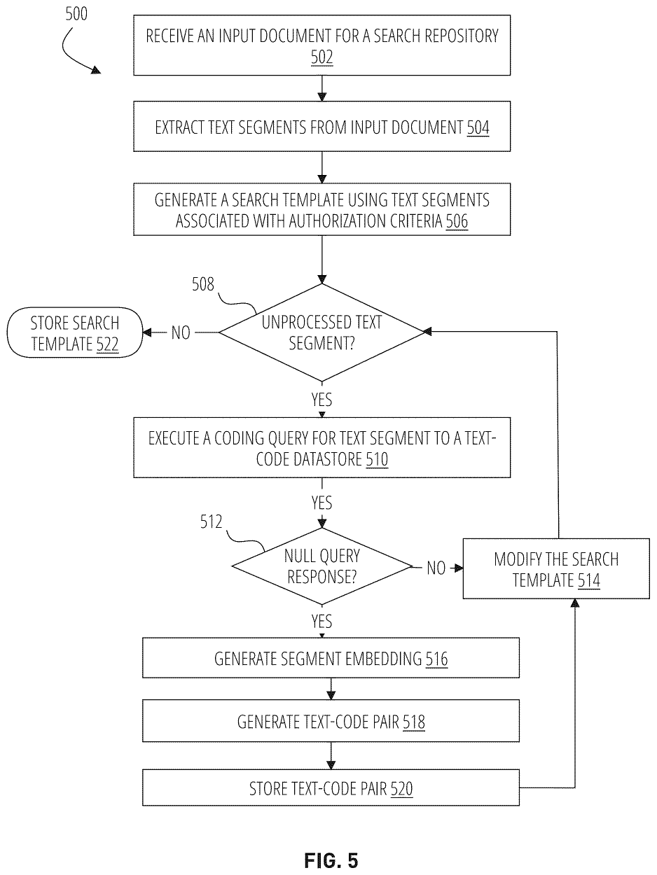

FIG. 5 depicts a flowchart diagram of an example process 500 for implementing a first, storage, stage of the multi-stage autonomous coding pipeline in accordance with some embodiments of the present disclosure. The flowchart depicts a branched processing technique that integrates machine learned embedding models into a continuous feedback learning loop to autonomously code a text segment without user input. The process 500 may be implemented by one or more computing devices, entities, and/or systems described herein. For example, via the various steps/operations of the process 500, the computing system 101 may leverage the branched processing technique to effectively transform an input document into a search template tailored for code-based retrieval systems. By doing so, the process 500 enables the creation and autonomous augmentation of a search repository for a code-based retrieval technique that solves several technical challenges of traditional search engines to improve the search and retrieval functionality of a computer.

FIG. 5 illustrates an example process 500 for explanatory purposes. Although the example process 500 depicts a particular sequence of steps/operations, the sequence may be altered without departing from the scope of the present disclosure. For example, some of the steps/operations depicted may be performed in parallel or in a different sequence that does not materially impact the function of the process 500. In other examples, different components of an example device or system that implements the process 500 may perform functions at substantially the same time or in a specific sequence.

In some embodiments, the process 500 comprises, at operation 502, receiving an input document. For example, the computing system 101 may receive the input document with a request to ingest the input document to a search repository.

In some embodiments, the process 500 comprises, at operation 504, extracting text segments from the input document. For example, the computing system 101 may extract text segment from the input document.

In some embodiments, the process 500 comprises, at operation 506, generating a search template using a portion of the text segments that are associated with authorization criteria. For example, the computing system 101 may generate a search template using the portion of the text segments that are associated with authorization criteria. For example, the computing system 101 may generate the search template for the input document by extracting the text segments from the input document and storing the text segments into a structure data structure. In addition, or alternatively, an empty search template may be generated, and the authorization criteria may be extracted for one or more text segments from the input document that are mapped to a code defined within a coding domain.

In some embodiments, the process 500 comprises, at operation 508, detecting an unprocessed text segment. For example, the computing system 101 may detect an unprocessed text segment based on a present of the text segment within a processing queue. In response to detecting the unprocessed text segment, the process 500 may continue to operation 510, where a coding query is executed to transform the text segment to a related code. Otherwise, the process 500 may proceed to operation 522, where the search template is stored within a search repository tailored for code-based retrieval.

In some embodiments, the process 500 comprises, at operation 510, executing a coding query for a text segment to a text-code datastore. For example, the computing system 101 may execute the coding query for the text segment to the text-code datastore. For example, the computing system 101 may execute, to a text-code datastore of the search repository, a coding query for the text segment to receive a query response. In some examples, the text-code datastore comprises a hash table that comprises a set historical text-code pairs respectively indexed by a set of hashed identifiers. The computing system 101 may generate, using a hashing model, a hashed query identifier by hashing the text segment and may execute the coding query with the hashed query identifier.

In some embodiments, the process 500 comprises, at operation 512, detecting a null query response. For example, the computing system 101 may receive a query response to the coding query that may either comprise text-code pair for a text segment or comprise null value indicating that not text-code pair matches the text segment. The computing system 101 may determine that the query response is a null query response if the query response comprises a null value. In response to detecting the null query response, the process 500 may continue to operation 516, where an autonomous coding process is executed to map the text segment to a related code. Otherwise, the process 500 may proceed to operation 514, where the search template is modified to store the code of a returned text-code pair within search template and in association with authorization criteria defined for the text segment.

In some embodiments, the process 500 comprises, at operation 516, generating a segment embedding using a machine learned encoder model. For example, the computing system 101 may generate the segment embedding using the machine learned encoder model. For example, responsive to the null query response, the computing system 101 may generate, using a machine learned encoder model, a segment embedding based on the text segment.

In some embodiments, the process 500 comprises, at operation 518, generating a text-code pair based on an embedding similarity score. For example, the computing system 101 may, generate the text-code pair based on the embedding similarity score. For example, responsive to the null query response, the computing system 101 may generate the text-code pair for the text segment based on the embedding similarity score between the segment embedding and a code embedding.

In some embodiments, the process 500 comprises, at operation 520, storing the text-code pair within the text-code datastore. For example, responsive to the null query response, the computing system 101 may store the text-code pair within the text-code datastore.

In some embodiments, the process 500 comprises, at operation 514, modifying the search template by storing the code in association with the text segment. For example, responsive to the null query response, the computing system 101 may modify the search template by storing the code of the text-code pair in association with the text segment. In some examples, the computing system 101 may further extract authorization criteria from the input document that corresponds to the text segment and store the authorization criteria in association with the text-code pair.

In some embodiments, the process 500 comprises, at operation 522, storing the search template in a search repository. For example, the computing system 101 may store the search template in the search repository. In some examples, the computing system 101 may perform a redundancy check and, in response to the cleared redundancy check, store the search template in the search repository. For instance, the text segment may be one of a set of text segments stored within the search template with their associated codes. The set of text segments may be respectively associated with a set of previously identified codes. After the addition of a new code, the computing system 101 may detect a duplicate code based on a comparison between the new code and the set of previously identified codes. The computing system 101 may generate a data redundancy flag based on the duplicate code. In response to a data redundancy flag, the computing system 101 may output the search template for manual review. Otherwise, the computing system 101 may store the search template in the search repository. In some examples, the input document may be associated with a document identifier and the search template may indexed within the search repository based on the document identifier.

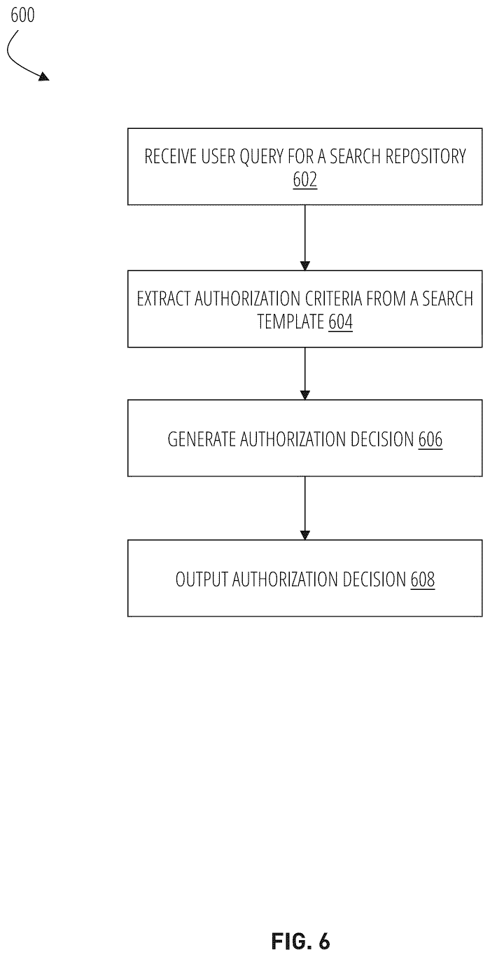

FIG. 6 depicts a flowchart diagram of an example process 600 for implementing a code-based retrieval technique in accordance with some embodiments of the present disclosure. The flowchart depicts a code-based retrieval technique that leverages a search repository of search templates, transformed from text-based documents, to improve retrieval speeds, accuracy, and consistency of search results related to any coding domain. The process 600 may be implemented by one or more computing devices, entities, and/or systems described herein. For example, via the various steps/operations of the process 600, the computing system 101 may leverage the code-based retrieval technique to effectively and consistently process queries related to a coding domain. By doing so, the process 600 enables the post query processing tasks that have traditionally been outside the scope of a computer due the lack of consistency of traditional search engines.

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process 600 comprises, at operation 602, receiving a user query for a search repository that comprises a document identifier, an input code, and/or contextual data. For example, the computing system 101 may receive the user query for the search repository that comprises a document identifier and/or an input code.

In some embodiments, the process 600 comprises, at operation 604, identifying authorization criteria from a search template based on the input code. For example, the computing system 101 may identify the authorization criteria from the search based on a comparison between the input code and a search template.

In some embodiments, the process 600 comprises, at operation 606, generating an authorization decision based on the authorization criteria. For example, the computing system 101 may apply the authorization criteria to the contextual data to determine an authorization decision and generate the authorization decision based on the authorization criteria.

In some embodiments, the process 600 comprises, at operation 608, outputting an authorization decision in response to the user query. For example, the computing system 101 may output an output text segment based on the document identifier, the input code, and/or a search template corresponding to the document identifier and/or input code. In some examples, the output text segment may comprise an authorization decision for the user query that is based on authorization criteria. In addition, or alternatively, the computing system 101 may identify the output text segment from a search template based on a comparison between the input code and the search template and output the output text segment in response to the user query.

Some techniques of the present disclosure enable the generation of action outputs that may be performed to initiate one or more real world actions to achieve real-world effects. The techniques of the present disclosure may be used, applied, and/or otherwise leveraged to extract codes reflective of actionable insights that may depend on a coding domain. These actionable insights, for example, may trigger action outputs (e.g., through control instructions) to automate computer performance actions, clinical actions, and/or the like. The action outputs may control various aspects of a client device, such as the display, transmission, and/or the like of data reflective of authorization decisions, authorization criteria, and/or the like. In some embodiments, codes and/or authorization decisions based thereon may trigger an alert, and/or the like. The alert may be automatically communicated to a user and/or may be used to initiate a security protocol (e.g., locking a computer), a robotic action (e.g., performing an automated screening process), and/or the like.

In some examples, the computing tasks may comprise actions that may be based on a coding domain. A coding domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

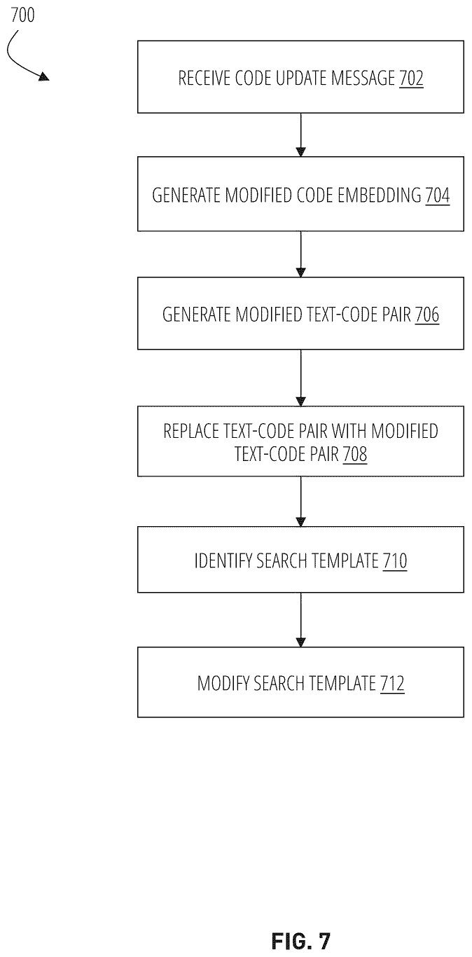

FIG. 7 depicts a flowchart diagram of an example process 700 for implementing a second, modification, stage of the multi-stage autonomous coding pipeline in accordance with some embodiments of the present disclosure. The flowchart depicts a continuous state monitoring technique that adaptively updates a search repository and related data structures (e.g., text-code datastores) to maintain a reliable and consistent code interpretation within a dynamically changing coding domain. The process 700 may be implemented by one or more computing devices, entities, and/or systems described herein. For example, via the various steps/operations of the process 700, the computing system 101 may leverage the continuous state monitoring technique to effectively update search templates over time to accommodate changes within a coding domain. By doing so, the process 700 enables consistent code-based retrieval in dynamically changing environments that solves several technical challenges of traditional search engines to improve the search and retrieval functionality of a computer.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 comprises, at operation 702, receiving code update message that comprises a modified code. For example, the computing system 101 may receive a code update message that comprises a modified code. The code update message may identify a code modification to a code definition of the code. In some examples, responsive to the code update message, the computing system 101 may remove text-code pairs corresponding to the modified code from the text-code datastore and one or more of the search templates that comprise the modified code.

In some embodiments, the process 700 comprises, at operation 704, generating a modified code embedding for the modified code. For example, the computing system 101 may generate a modified code embedding for the modified code based on the code modification.

In some embodiments, the process 700 comprises, at operation 706, generating one or more modified text-code pairs for the modified code based on the modified code embedding. For example, the computing system 101 may generate one or more modified text-code pairs for the modified code based on the modified code embedding. For instance, the computing system may regenerate the text-code pairs for one or more of the text segments previously mapped to the modified code based on an embedding similarity score between the segment embeddings of the text segments and the modified code embedding.

In some embodiments, the process 700 comprises, at operation 708, replacing text-code pairs for the modified code within a text-code datastore with the modified text-code pairs. update message that comprises a modified code. For example, the computing system 101 may replace the text-code pairs for the modified code within the text-code datastore with the modified text-code pairs. For instance, the computing system 101 may restore a new text-code pair for one or more of the text segments previously mapped to the modified code within the text-code datastore.

In some embodiments, the process 700 comprises, at operation 710, identifying a search template that comprises the modified code. For example, the computing system 101 may identify the search template that comprises the modified code.

In some embodiments, the process 700 comprises, at operation 712, modifying the search template based on the modified text-code pairs. For example, the computing system 101 may modify the search template based on the modified text-code pairs. For instance, the computing system 101 may modify the search template by restoring the code of the text-code pair in association with the text segment.

### Iv. CONCLUSION

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each operation may be performed by any one or combination of computing devices, entities, and/or systems described herein. For example, a computing system may comprise a single computing entity that is configured to perform the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform the steps/operations of a particular example.

Example 1. A computer-implemented method comprising receiving, by one or more processors, an input document for storage within a search repository; generating, by the one or more processors, a search template for the input document by extracting a text segment from the input document; providing, by the one or more processors and to a text-code datastore of the search repository, a coding query determined based on the text segment to receive a query response; determining, by the one or more processors, that the query response is a null query response; and responsive to the null query response, (i) generating, by the one or more processors and using a machine learned encoder model, a segment embedding based on the text segment, (ii) generating, by the one or more processors, a text-code pair for the text segment based on an embedding similarity score between the segment embedding and a code embedding, (iii) storing, by the one or more processors, the text-code pair within the text-code datastore, and (iv) modifying, by the one or more processors, the search template by storing a code of the text-code pair in association with the text segment.

Example 2. The computer-implemented method of example 1, wherein (i) the text segment is one of a set of text segments stored within the search template, (ii) the set of text segments is respectively associated with a set of previously identified codes, and (iii) the computer-implemented method further comprises detecting a duplicate code based on a comparison between the code and the set of previously identified codes, and generating a data redundancy flag based on the duplicate code.

Example 3. The computer-implemented method of any of the preceding examples, wherein the input document is associated with a document identifier and the search template is indexed within the search repository based on the document identifier.

Example 4. The computer-implemented method of example 3, further comprising receiving a user query for the search repository that comprises the document identifier and an input code; identifying an output text segment from a search template based on a comparison between the input code and the search template; and outputting the output text segment in response to the user query.

Example 5. The computer-implemented method of any of the preceding examples, further comprising extracting authorization criteria from the input document that corresponds to the text segment; and storing the authorization criteria in association with the text-code pair.

Example 6. The computer-implemented method of example 5, further comprising receiving a user query for the search repository that comprises the code and contextual data; identifying the authorization criteria based on a comparison between the code and the search template; applying the authorization criteria to the contextual data to determine an authorization decision; and outputting the authorization decision in response to the user query.

Example 7. The computer-implemented method of example 1, wherein the code is one of a set of codes defined within a coding domain and the computer-implemented method further comprises receiving a code update message that identifies a code modification to a code definition of the code; and responsive to the code update message, removing the text-code pair from the text-code datastore and the search template; generating a modified code embedding for the code based on the code modification; regenerating the text-code pair for the text segment based on an embedding similarity score between the segment embedding and the modified code embedding; restoring the text-code pair within the text-code datastore; and modifying the search template by restoring the code of the text-code pair in association with the text segment.

Example 8. The computer-implemented method of any of the preceding examples, wherein the text-code datastore comprises a hash table that comprises a set historical text-code pairs respectively indexed by a set of hashed identifiers.

Example 9. The computer-implemented method of example 8, wherein providing the coding query comprises generating, using a hashing model, a hashed query identifier by hashing the text segment; and executing the coding query with the hashed query identifier.

Example 10. A system comprising one or more processors and at least one memory storing processor-executable instructions that, when executed by the one or more processors, cause the one or more processors to perform operations comprising receiving an input document for storage within a search repository; generating a search template for the input document by extracting a text segment from the input document; providing, to a text-code datastore of the search repository, a coding query determined based on the text segment to receive a query response; determining that the query response is a null query response; and responsive to the null query response, (i) generating, using a machine learned encoder model, a segment embedding based on the text segment, (ii) generating a text-code pair for the text segment based on an embedding similarity score between the segment embedding and a code embedding, (iii) storing the text-code pair within the text-code datastore, and (iv) modifying the search template by storing a code of the text-code pair in association with the text segment.

Example 11. The system of example 10, wherein (i) the text segment is one of a set of text segments stored within the search template, (ii) the set of text segments is respectively associated with a set of previously identified codes, and (iii) the computer-implemented method further comprises detecting a duplicate code based on a comparison between the code and the set of previously identified codes, and generating a data redundancy flag based on the duplicate code.

Example 12. The system of any of examples 10 through 11, wherein the input document is associated with a document identifier and the search template is indexed within the search repository based on the document identifier.

Example 13. The system of example 12, wherein the operations further comprise receiving a user query for the search repository that comprises the document identifier and an input code; identifying an output text segment from a search template based on a comparison between the input code and the search template; and outputting the output text segment in response to the user query.

Example 14. The system of example 10, wherein the operations further comprise extracting authorization criteria from the input document that corresponds to the text segment; and storing the authorization criteria in association with the text-code pair.

Example 15. The system of example 14, wherein the operations further comprise receiving a user query for the search repository that comprises the code and contextual data; identifying the authorization criteria based on a comparison between the code and the search template; applying the authorization criteria to the contextual data to determine an authorization decision; and outputting the authorization decision in response to the user query.

Example 16. The system of any of examples 10 through 15, wherein the code is one of a set of codes defined within a coding domain and the computer-implemented method further comprises receiving a code update message that identifies a code modification to a code definition of the code; and responsive to the code update message, removing the text-code pair from the text-code datastore and the search template; generating a modified code embedding for the code based on the code modification; regenerating the text-code pair for the text segment based on an embedding similarity score between the segment embedding and the modified code embedding; restoring the text-code pair within the text-code datastore; and modifying the search template by restoring the code of the text-code pair in association with the text segment.

Example 17. The system of any of examples 10 through 16, wherein the text-code datastore comprises a hash table that comprises a set historical text-code pairs respectively indexed by a set of hashed identifiers.

Example 18. One or more non-transitory computer-readable storage media storing instructions that, when executed by one or more processors, cause the one or more processors to perform operations comprising receiving an input document for storage within a search repository; generating a search template for the input document by extracting a text segment from the input document; providing, to a text-code datastore of the search repository, a coding query determined based on the text segment to receive a query response; determining that the query response is a null query response; and responsive to the null query response, (i) generating, using a machine learned encoder model, a segment embedding based on the text segment, (ii) generating a text-code pair for the text segment based on an embedding similarity score between the segment embedding and a code embedding, (iii) storing the text-code pair within the text-code datastore, and (iv) modifying the search template by storing a code of the text-code pair in association with the text segment.

Example 19. The one or more non-transitory computer-readable storage media of example 18, wherein the text-code datastore comprises a hash table that comprises a set historical text-code pairs respectively indexed by a set of hashed identifiers.

Example 20. The one or more non-transitory computer-readable storage media of example 19, wherein executing the coding query comprises generating, using a hashing model, a hashed query identifier by hashing the text segment; and executing the coding query with the hashed query identifier.

1. A computer-implemented method comprising:
receiving, by one or more processors, an input document for storage within a search repository associated with a search engine;
generating and storing, by the one or more processors, a search template for the input document by extracting a text segment from the input document, wherein the search template is associated with a document identifier and comprises a set of structured response entries to improve a retrieval speed of the search engine, and wherein the search template is indexed within the search repository based on the document identifier;
providing, by the one or more processors and to a text-code datastore of the search repository, a coding query determined based on the text segment to receive a query response;
determining, by the one or more processors, that the query response is a null query response;
responsive to the null query response,
(i) generating, by the one or more processors and using a machine learned encoder model, a segment embedding based on the text segment,
(ii) generating, by the one or more processors, a text-code pair for the text segment based on an embedding similarity score between the segment embedding and a code embedding,
(iii) storing, by the one or more processors, the text-code pair within the text-code datastore, and
(iv) modifying, by the one or more processors, the search template by storing a code of the text-code pair in association with the text segment;
receiving, by the one or more processors, a user query for the search repository that comprises an input code and the document identifier, wherein the input code is associated with contextual data; and
responsive to receiving the user query:
identifying, by the one or more processors, an authorization criteria based on a comparison between the input code and the search template, and
providing, by the one or more processors, a user query response based on the authorization criteria.

2. The computer-implemented method of claim 1, wherein:
(i) the text segment is one of a set of text segments stored within the search template,
(ii) the set of text segments is respectively associated with a set of previously identified codes, and
(iii) the computer-implemented method further comprises:
detecting a duplicate code based on a comparison between the code and the set of previously identified codes, and
generating a data redundancy flag based on the duplicate code.

3. (canceled)

4. (canceled)

5. (canceled)

6. The computer-implemented method of claim 1, further comprising:
applying the authorization criteria to the contextual data to determine an authorization decision, wherein the user query response comprises the authorization decision.

7. The computer-implemented method of claim 1, wherein the code is one of a set of codes defined within a coding domain and the computer-implemented method further comprises:
receiving a code update message that identifies a code modification to a code definition of the code; and
responsive to the code update message,
removing the text-code pair from the text-code datastore and the search template;
generating a modified code embedding for the code based on the code modification;
regenerating the text-code pair for the text segment based on an embedding similarity score between the segment embedding and the modified code embedding;
restoring the text-code pair within the text-code datastore; and
modifying the search template by restoring the code of the text-code pair in association with the text segment.

8. The computer-implemented method of claim 1, wherein the text-code datastore comprises a hash table that comprises a set historical text-code pairs respectively indexed by a set of hashed identifiers.

9. The computer-implemented method of claim 8, wherein providing the coding query comprises:
generating, using a hashing model, a hashed query identifier by hashing the text segment; and
executing the coding query with the hashed query identifier.

10. A system comprising one or more processors and at least one memory storing processor-executable instructions that, when executed by the one or more processors, cause the one or more processors to perform operations comprising:
receiving an input document for storage within a search repository associated with a search engine;
generating and storing a search template for the input document by extracting a text segment and authorization criteria corresponding to the text segment from the input document, wherein the search template is associated with a document identifier and comprises a set of structured response entries to improve a retrieval speed of the search engine, and wherein the search template is indexed within the search repository based on the document identifier;
providing, to a text-code datastore of the search repository, a coding query determined based on the text segment to receive a query response;
determining that the query response is a null query response; and
responsive to the null query response,
(i) generating, using a machine learned encoder model, a segment embedding based on the text segment,
(ii) generating a text-code pair for the text segment based on an embedding similarity score between the segment embedding and a code embedding,
(iii) storing the text-code pair within the text-code datastore, and
(iv) modifying the search template by storing a code of the text-code pair in association with the text segment;
receiving a user query for the search repository that comprises an input code and the document identifier, wherein the input code is associated with contextual data; and
responsive to receiving the user query.
identifying an authorization criteria based on a comparison between the input code and the search template, and
providing a user query response based on the authorization criteria.

11. The system of claim 10, wherein:
(i) the text segment is one of a set of text segments stored within the search template,
(ii) the set of text segments is respectively associated with a set of previously identified codes, and
(iii) the operations further comprise:
detecting a duplicate code based on a comparison between the code and the set of previously identified codes, and
generating a data redundancy flag based on the duplicate code.

12. (canceled)

13. (canceled)

14. (canceled)

15. The system of claim 10, wherein the operations further comprise:
applying the authorization criteria to the contextual data to determine an authorization decision, wherein the user query response comprises the authorization decision.

16. The system of claim 10, wherein the code is one of a set of codes defined within a coding domain and the operations further comprise:
receiving a code update message that identifies a code modification to a code definition of the code; and
responsive to the code update message,
removing the text-code pair from the text-code datastore and the search template;
generating a modified code embedding for the code based on the code modification;
regenerating the text-code pair for the text segment based on an embedding similarity score between the segment embedding and the modified code embedding;
restoring the text-code pair within the text-code datastore; and
modifying the search template by restoring the code of the text-code pair in association with the text segment.

17. The system of claim 10, wherein the text-code datastore comprises a hash table that comprises a set historical text-code pairs respectively indexed by a set of hashed identifiers.

18. One or more non-transitory computer-readable storage media storing instructions that, when executed by one or more processors, cause the one or more processors to perform operations comprising:
receiving an input document for storage within a search repository associated with a search engine;
generating and storing a search template for the input document by extracting a text segment from the input document, wherein the search template is associated with a document identifier and comprises a set of structured response entries to improve a retrieval speed of the search engine, and wherein the search template is indeed within the search repository based on the document identifier;
providing, to a text-code datastore of the search repository, a coding query determined based on the text segment to receive a query response;
determining that the query response is a null query response; and
responsive to the null query response,
(i) generating, using a machine learned encoder model, a segment embedding based on the text segment,
(ii) generating a text-code pair for the text segment based on an embedding similarity score between the segment embedding and a code embedding,
(iii) storing the text-code pair within the text-code datastore, and
(iv) modifying the search template by storing a code of the text-code pair in association with the text segment;
receiving a user query for the search repository that comprises an input code and the document identifier, wherein the input code is associated with contextual data; and
responsive to receiving the user query;
identifying an authorization criteria based on a comparison between the input code and the search template, and
providing a user query response based on the authorization criteria.

19. The one or more non-transitory computer-readable storage media of claim 18, wherein the text-code datastore comprises a hash table that comprises a set historical text-code pairs respectively indexed by a set of hashed identifiers.

20. The one or more non-transitory computer-readable storage media of claim 19, wherein executing the coding query comprises:
generating, using a hashing model, a hashed query identifier by hashing the text segment; and
executing the coding query with the hashed query identifier.

21. The one or more non-transitory computer-readable storage media of claim 18, wherein:
(i) the text segment is one of a set of text segments stored within the search template,
(ii) the set of text segments is respectively associated with a set of previously identified codes, and
(iii) the operations further comprise:
detecting a duplicate code based on a comparison between the code and the set of previously identified codes, and
generating a data redundancy flag based on the duplicate code.

22. The one or more non-transitory computer-readable storage media of claim 18, the operations further comprising:
applying the authorization criteria to the contextual data to determine an authorization decision, wherein the user query response comprises the authorization decision.

23. The one or more non-transitory computer-readable storage media of claim 18, wherein the code is one of a set of codes defined within a coding domain and the operations further comprise:
receiving a code update message that identifies a code modification to a code definition of the code; and
responsive to the code update message,
removing the text-code pair from the text-code datastore and the search template;
generating a modified code embedding for the code based on the code modification;
regenerating the text-code pair for the text segment based on an embedding similarity score between the segment embedding and the modified code embedding;
restoring the text-code pair within the text-code datastore; and
modifying the search template by restoring the code of the text-code pair in association with the text segment.
